(19) United States
(12) Patent Application Publication
(10) Pub. No.: US 2019/0294280 A1
(43) Pub. Date: Sep. 26, 2019

(54) MANUFACTURING METHOD FOR DISPLAY PANEL, DISPLAY PANEL AND DISPLAY DEVICE

(71) Applicant: Wuhan China Star Optoelectronics Semiconductor Display Technology Co., Ltd., Wuhan (CN)

(72) Inventor: Mian ZENG, Shenzhen (CN)

(21) Appl. No.: 16/017,508

(22) Filed: Jun. 25, 2018

Related U.S. Application Data
(63) Continuation of application No. PCT/CN2018/087207, filed on May 17, 2018.

(30) Foreign Application Priority Data
Mar. 21, 2018 (CN) 201810235247.X

(51) Int. Cl. G06F 3/041

(52) U.S. Cl. CPC G06F 3/0412; G06F 2203/04103

(57) ABSTRACT

The invention provides a manufacturing method for display panel, display panel and display device. The display panel comprises a plurality of pixel units. Each pixel unit comprises a light-emitting element and a TFT, the light-emitting element comprises: an anode and a first touch electrode, disposed in a same layer, a light-emitting layer disposed on the anode and the first touch electrode, and a first electrode disposed on the light-emitting layer. The first electrode serves as a cathode of the display panel and a second touch electrode of the display panel in a time division manner. As such, the invention can reduce the thickness of the display panel and thickness of display device.

### BACKGROUND OF THE INVENTION

### 1. Field of the Invention

The present invention relates to the field of touch display and, in particular, to the field of manufacturing method for display panel, display panel and display device.

### 2. The Related Arts

Active matrix organic light-emitting diode (AMOLED) display provides the advantages of high response speed, power saving, applicability to portable devices, wide operating temperature range, higher contrast, and wider viewing angle. As such, AMOLED is expected to become the next generation of new flat panel display replacing liquid crystal display (LCD). As the flexible AMOLED has the advantages of being light and thin, bendable or foldable, and the shape of the flexible AMOLED can be arbitrarily changed, it has received increasing attention from the market.

In general, smart mobile displays need to integrate touch screen technology in order to facilitate user for use and operation. Therefore, in smart mobile displays, AMOLED display technology and touch technology need to be combined; in addition, the demands for thin screen are also increasing higher, therefore, how to combine the display technology with the touch technology to make the light-emitting device thinner has become an issue to be addressed.

### SUMMARY OF THE INVENTION

The primary object of the present invention is to provide a manufacturing method for display panel, display panel and display device, able to reduce the thickness of the display panel and leading to thinner display device.

To solve the above problems, the present invention provides a display panel, which comprises: a plurality of pixel units. Each pixel unit comprises a light-emitting element and a thin film transistor (TFT). The light-emitting element comprises an anode and a first touch electrode, disposed in a same layer; a light-emitting layer disposed on the anode and the first touch electrode; and a first electrode disposed on the light-emitting layer. The first electrode serves as a cathode of the display panel and a second touch electrode of the display panel in a time division manner.

To solve the above problems, the present invention also provides a manufacturing method for display panel, which comprises; providing a base substrate; forming a thin film transistor (TFT) on the base substrate; forming an anode and a first touch electrode on the TFT, wherein the anode and the first touch electrode being disposed in a same layer; forming a light-emitting layer and a first electrode layer sequentially formed on the anode; the first electrode serving as a cathode of the display panel and a second touch electrode of the display panel in a time division manner.

To solve the above problems, the present invention also provides a display device, which comprises a display panel, and the display panel comprising: a plurality of pixel units, each pixel unit comprising a light-emitting element and a thin film transistor (TFT); the light-emitting element comprising an anode and a first touch electrode disposed in a same layer; a light-emitting layer disposed on the anode and the first touch electrode, and a first electrode disposed on the light-emitting layer; the first electrode serving as a cathode of the display panel and a second touch electrode of the display panel in a time division manner; a planarization layer being disposed between the TFT and the light-emitting element, the anode being connected to a source or a drain of the TFT through a via in the planarization layer; the display panel further comprising a pixel definition layer, located in non-light-emitting region and covering the anode, the first touch electrode, and the planarization layer, and serving as an insulating layer between the first touch electrode and the second touch electrode; the pixel definition layer having a thickness at area corresponding to the first touch electrode less than a thickness at other areas of the pixel defining layer; the first touch electrode being disposed between adjacent anodes.

Compared to the known technology, the present invention provides the following advantages: the present invention, by disposing a first touch electrode in the same layer as the anode of the display panel, a light-emitting layer on the anode and the first touch electrode, and a first electrode on the light-emitting layer, uses the first electrode as a cathode of the display panel and a second touch electrode of the display panel in a time division manner. The first touch electrode and the second touch electrode serve as touch drive electrode or touch sense electrode. As such, the touch electrodes are embedded in the regions where the cathode and the anode of the display panel are located. On one hand, the thickness of the display device caused by attaching the touch panel to a package structure is avoided, thereby reducing the thickness of the display device. On the other hand, the existing cathode can also be used as a touch electrode, which reduces the number of manufacturing steps and reduces the production cost.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort.

FIG. 1 is a cross-sectional view showing the structure of a known display device.

FIG. 2 is a schematic view showing the structure of gate lines and data lines of the display panel provided by an embodiment of the present invention.

FIG. 3 is a cross-sectional view showing the structure of the display panel provided by an embodiment of the present invention.

FIG. 4 is a flowchart showing the structure of first touch electrode and second touch electrode of a display panel provided by an embodiment of the present invention.

FIG. 5 is another flowchart showing the structure of first touch electrode and second touch electrode of a display panel provided by an embodiment of the present invention.

FIG. 6 is a cross-sectional view showing the structure of the display panel provided by another embodiment of the present invention.

FIG. 7 is a cross-sectional view showing the structure of the display panel provided by yet another embodiment of the present invention.

FIG. 8 is a flowchart showing the manufacturing method for display panel provided by an embodiment of the present invention.

FIG. 9 is a cross-sectional view showing display panel of the manufacturing method for display panel provided by an embodiment of the present invention.

FIG. 10 is a flowchart showing the manufacturing method for display panel provided by another embodiment of the present invention.

FIG. 11 is a cross-sectional view showing display panel of the manufacturing method for display panel provided by another embodiment of the present invention.

FIG. 12 is a schematic view showing the structure of a display device provided by an embodiment of the present invention.

### DETAILED DESCRIPTION OF THE PREFERRED EMBODIMENTS

To further explain the technical means and effect of the present invention, the following refers to embodiments and drawings for detailed description. Apparently, the described embodiments are merely some embodiments of the present invention, instead of all embodiments. All other embodiments based on embodiments in the present invention and obtained by those skilled in the art without departing from the creative work of the present invention are within the scope of the present invention.

The terms “comprising” and “having” and any variations thereof appearing in the specification, claims, and drawings of the present application are intended to cover non-exclusive inclusion. For example, a process, method, system, product, or device that includes a series of steps or units is not limited to the listed steps or units, but optionally also includes steps or units not listed, or alternatively, other steps or units inherent to these processes, methods, products or equipment. In addition, the terms “first”, “second” and “third” are used to distinguish different objects and not intended to describe a particular order.

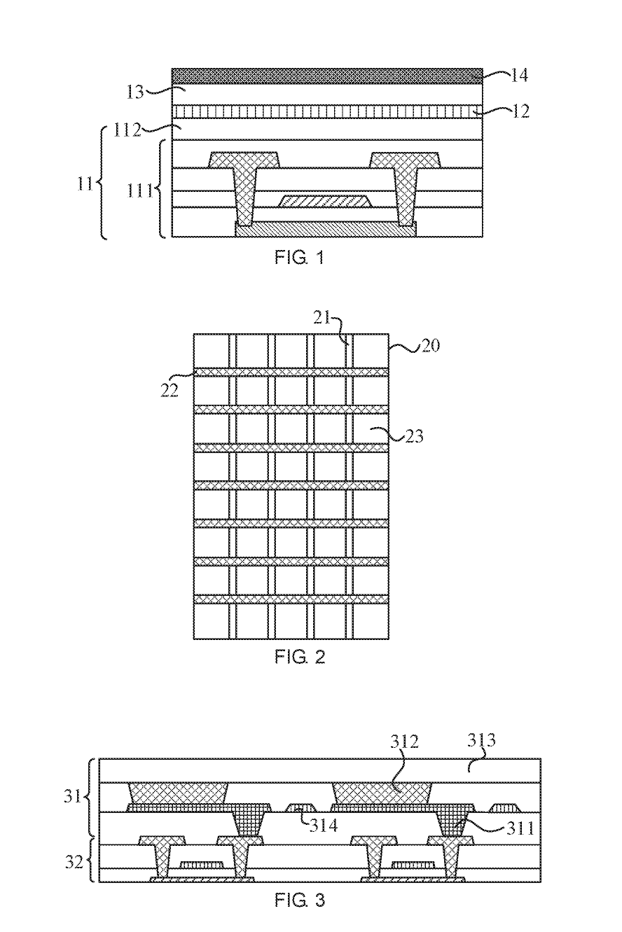

As shown in FIG. 1, in the known technology, a display panel 11 comprises a TFT 111 and an OLED element 112. A package structure 12 is added on the basis of the display panel 11, and then a touch screen 13 is attached on the package structure 12 to form a display panel with touch function. Finally, a cover glass 14 is attached to the touch screen 13; sometimes, to enhance the strength of the cover glass 14, a reinforced glass must be used, which causes the overall thickness of the light-emitting device in the known technology to become relatively large, high weight and high cost.

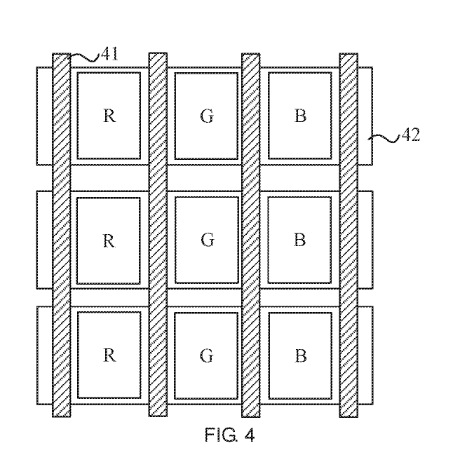

Refer to FIG. 2. FIG. 2 is a schematic view showing the structure of gate lines and data lines of the display panel provided by an embodiment of the present invention. The display panel 20 comprises a plurality of pixel units 23 surrounded by data lines 21 and gate lines 22 arranged in an intersecting manner. Refer to FIG. 3, FIG. 3 is a cross-sectional view showing the structure of the display panel provided by an embodiment of the present invention. Each of the pixel units 23 comprises a light-emitting element 31 and at least one TFT 32. The light-emitting element 31 comprises an anode 311 and the first touch electrode 314, disposed in a same layer, a light-emitting layer 312 disposed on the anode 311 and the first touch electrode 314, and a first electrode 313 disposed on the light-emitting layer 312; the first electrode 313 serves as a cathode of the display panel and a second touch electrode of the display panel in a time division manner.

Optionally, the anode 311 and the first touch electrode 314 are obtained by patterning the same metal layer.

It should be noted that when different voltages are applied to the anode 311 and the cathode respectively, an electric field is formed between the anode 311 and the cathode, which makes the light-emitting layer 312 in the middle to emit light to display. Furthermore, by changing the voltages on the anode 311 or the cathode so that the electric field is changed, the light-emitting intensity of the light-emitting layer 312 is changed, thereby displaying with different brightness.

Specifically, the first touch electrode 314 can be a touch driving electrode and the second touch electrode can be a touch sensing electrode.

It should be noted that in the present embodiment, using the first electrode 313 as the cathode as well as the touch electrode can be implemented in a time division manner. For example, in a frame, the first electrode 313 is used as a cathode in the first half-frame, and the first electrode 313 is used as a touch electrode in the second half-frame.

It should be noted that, in the above embodiment, the properties and order of the electrodes are not restricted; for example, in other embodiments, the anode 311 may also be used as a cathode, and the first electrode 313 may be used as an anode, wherein the anode is also used as a touch electrode. In addition, the first touch electrode may also be used as a touch sensing electrode, and the second touch electrode may be used as a touch driving electrode.

Optionally, in an embodiment, the first touch electrodes and the second touch electrodes are arranged as follows:

As shown in FIG. 4, the first touch electrodes 41 are evenly arranged in the column direction, the second touch electrodes 42 are evenly arranged in the row direction, and the first touch electrodes 41 are arranged in the non-light-emitting region of the display panel, which may specifically be the black matrix area between two adjacent pixels.

The two adjacent first touch electrodes 41 are separated by at least one column of pixel units, and two adjacent second touch electrodes 42 are insulated from each other, for preventing the two adjacent first touch electrodes 41 or two adjacent second touch electrodes 42 from crosstalk.

Optionally, in another embodiment, the arrangement of the first touch electrodes 41 and the second touch electrodes 42 is as follows:

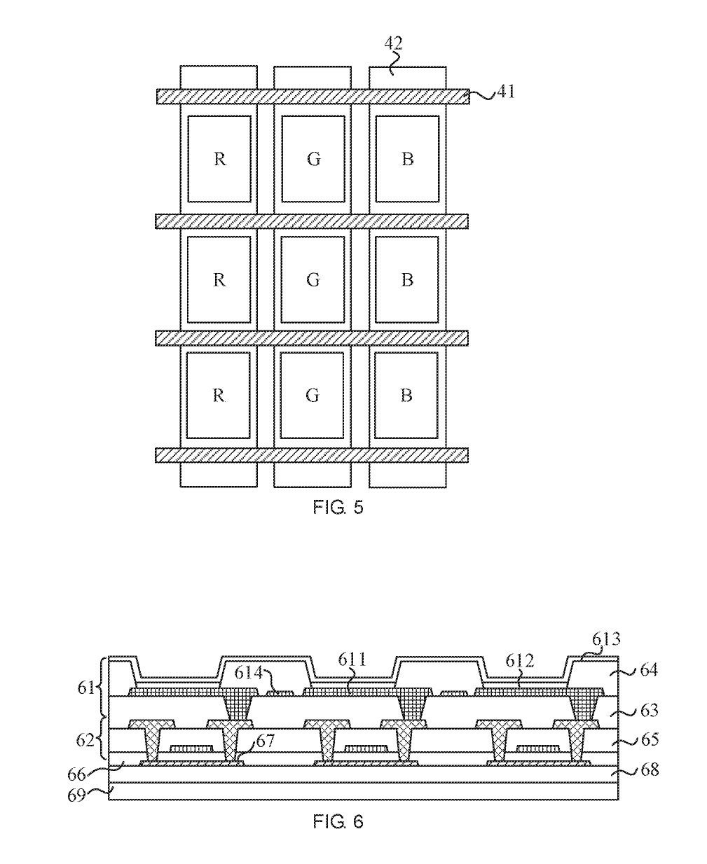

As shown in FIG. 5, the first touch electrodes 41 are evenly arranged in the row direction, the second touch electrodes 42 are evenly arranged in the column direction, and the first touch electrodes 41 are arranged in the non-light-emitting region of the display panel, which may specifically be the black matrix area between two adjacent pixels.

The two adjacent first touch electrodes 41 are separated by at least one row of pixel units, and two adjacent second touch electrodes 42 are insulated from each other, for preventing the two adjacent first touch electrodes 41 or two adjacent second touch electrodes 42 from crosstalk.

Moreover, the interval between the two first touch electrodes 41 can be flexibly configured according to actual needs to achieve different precision of touch; two or more first touch electrodes 41 can be connected at both ends to form a first touch line to reduce the resistance of the first touch line and improve signal transmission efficiency.

It should be noted that one of the first touch electrode 41 and the second touch electrode 42 is used as a touch driving electrode, and the other is used as a touch sensing electrode; that is, the first touch electrode 41 is used as a touch driving electrode, and the second touch electrode 42 is used as a touch sensing electrode; or the first touch electrode 41 is used as a touch sensing electrode, and the second touch electrode 42 is used as a touch driving electrode.

Compared to the known technology, the display panel provided by the present embodiment, by disposing a first touch electrode in the same layer as the anode of the display panel, a light-emitting layer on the anode and the first touch electrode, and a first electrode on the light-emitting layer, uses the first electrode as a cathode of the display panel and a second touch electrode of the display panel in a time division manner. The first touch electrode and the second touch electrode serve as touch drive electrode or touch sense electrode. As such, the touch electrodes are embedded in the regions where the cathode and the anode of the display panel are located. On one hand, the thickness of the display device caused by attaching the touch panel to a package structure is avoided, thereby reducing the thickness of the display device. On the other hand, the existing cathode can also be used as a touch electrode, which reduces the number of manufacturing steps and reduces the production cost.

Refer to FIG. 6. FIG. 6 is a cross-sectional view showing the structure of the display panel provided by another embodiment of the present invention. The display panel comprises a plurality of pixel units surrounded by data lines and gate lines arranged in an intersecting manner. Each of the pixel units comprises a light-emitting element 61 and at least one TFT 62. The light-emitting element 61 comprises an anode 611 and the first touch electrode 614, disposed in a same layer, a light-emitting layer 612 disposed on the anode 611 and the first touch electrode 614, and a first electrode 613 disposed on the light-emitting layer 612; the first electrode 613 serves as a cathode of the display panel and a second touch electrode of the display panel in a time division manner.

Wherein the first touch electrode 614 is disposed between two adjacent anodes 611.

A planarization layer 63 is disposed between the TFT 62 and the light-emitting element 61, and the anode 611 is connected to a source or a drain of the TFT 62 through a via in the planarization layer 63.

The display panel further comprises a pixel definition layer 64, located in non-light-emitting region and covering the anode 611, the first touch electrode 614 and the planarization layer 63, and serving as an insulating layer between the first touch electrode 614 and the second touch electrode.

It should be noted that in this embodiment, the first touch electrode 614 is used as a touch driving electrode, and the second touch electrode is used as a touch sensing electrode; or the first touch electrode 614 is used as a touch sensing electrode, and the second touch electrode is used as a touch driving electrode.

The display panel further comprises: a base substrate 69, a buffer layer 68 disposed on the base substrate 69, a polysilicon layer 67 disposed on the buffer layer 68, a gate insulating layer 66 disposed on the polysilicon layer 67, and an interlayer insulating layer 65 disposed on the gate insulating layer 66. The source and drain of the TFT 62 are connected to the polysilicon layer 67 through vias in the interlayer insulating layer 65 and the gate insulating layer 66.

To add the routing of the first touch electrode 614 in the existing anode layer pattern, the first touch electrode 614 and the anode pattern can be formed by a same mask; the existing cathode layer is patterned to not only be used as the cathode electrode but also a routing of the second touch electrode. The routing of the first touch electrode 614 intersects with the routing of the second touch electrode.

In the present embodiment, the arrangement of the first touch electrodes 614 and the second touch electrodes is the same as on the previous embodiment and will not be repeated here.

Compared to the known technology, the display panel provided by the present embodiment, by disposing a first touch electrode in the same layer as the anode of the display panel, a light-emitting layer on the anode and the first touch electrode, and a first electrode on the light-emitting layer, uses the first electrode as a cathode of the display panel and a second touch electrode of the display panel in a time division manner. The routing of the first touch electrodes and the routing of the second touch electrodes are disposed in an intersecting manner so that the touch electrodes are embedded in the display panel to avoid the thickness issue of the display device caused by attaching the touch panel to a package structure, thereby reducing the thickness of the display device. Also, the existing cathode can also be used as a touch electrode, which reduces the number of manufacturing steps and reduces the production cost

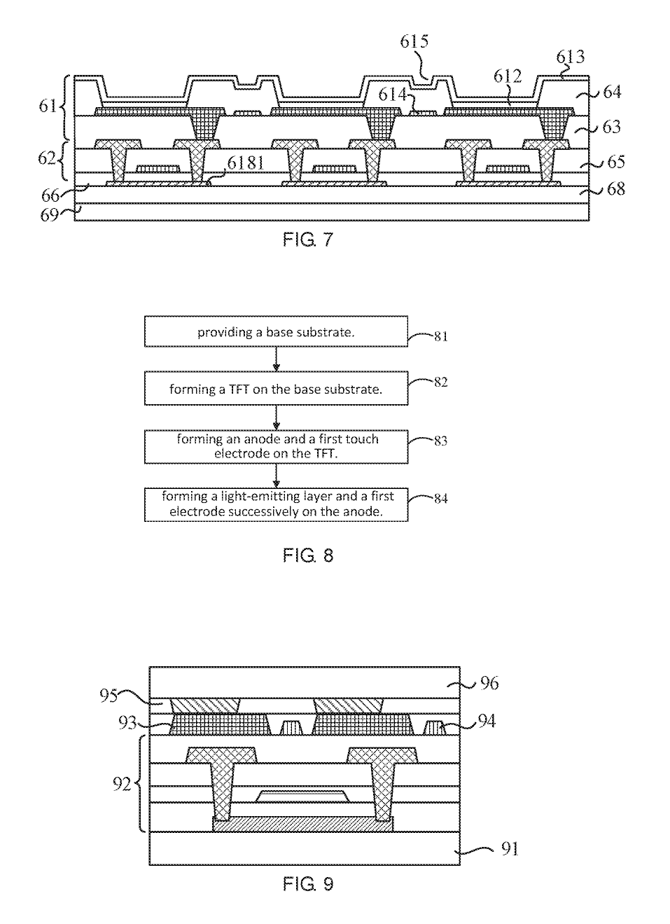

Refer to FIG. 7. FIG. 7 is a cross-sectional view showing the structure of the display panel provided by yet another embodiment of the present invention. The present embodiment is based on the previous embodiment and has the same basic structure. To reduce the pixel definition layer to increase the touch sensing performance, the thickness of the pixel definition layer 64 has a thickness at area corresponding to the first touch electrode 614 less than a thickness at other areas of the pixel defining layer. A half-tone mask may be used to reduce the thickness of the pixel definition layer 64 at area corresponding to the first touch electrode 614, that is, a groove 615 exists in the area of the pixel definition layer corresponding to the first touch electrode 614.

Compared to the known technology, the display panel provided by the present embodiment, by disposing a first touch electrode in the same layer as the anode of the display panel, a light-emitting layer on the anode and the first touch electrode, and a first electrode on the light-emitting layer, uses the first electrode as a cathode of the display panel and a second touch electrode of the display panel in a time division manner. The routing of the first touch electrodes and the routing of the second touch electrodes are disposed in an intersecting manner so that the touch electrodes are embedded in the display panel to avoid disposing additional touch panel to reduce the thickness of the light-emitting element and save production cost. Also, reducing the thickness of the pixel definition layer corresponding to the first touch electrode can enhance the touch sensitivity.

Refer to FIG. 8 and FIG. 9. FIG. 8 is a flowchart showing the manufacturing method for display panel provided by an embodiment of the present invention. The method comprises:

Step 81: providing a base substrate.

Step 82: forming a TFT on the base substrate.

The TFT comprises a source, a drain and a gate.

Step 83: forming an anode and a first touch electrode on the TFT.

The anode and the first touch electrode are disposed on the same layer and mutually insulated. The first touch electrode is disposed in non-light-emitting region.

Step 84: forming a light-emitting layer and a first electrode successively on the anode.

As shown in FIG. 9, FIG. 9 is a cross-sectional view showing display panel of the manufacturing method for display panel provided by an embodiment of the present invention. The display panel comprises a base substrate 91, a TFT 92 disposed on the base substrate 91, an anode 93 and a first touch electrode 94 disposed on the TFT92, and a light-emitting layer 95 and a first electrode 96 disposed on the anode 93.

The anode 93, light-emitting layer 95 and the first electrode 96 form a light-emitting element. The anode 93 is the anode of the light-emitting element, the first electrode 96 serves as a cathode of the display panel and a second touch electrode of the display panel in a time division manner.

In the present embodiment, the arrangement of the first touch electrodes and the second touch electrodes is the same as on the previous embodiment and will not be repeated here.

Compared to the known technology, the manufacturing method for the display panel provided by the present invention, by forming a first touch electrode at the layer of the anode, forming light-emitting layer and first electrode on the anode, uses the first electrode as a cathode of the display panel and a second touch electrode of the display panel in a time division manner. As such, the touch function is integrated into the display panel to reduce the thickness of the display and save production cost.

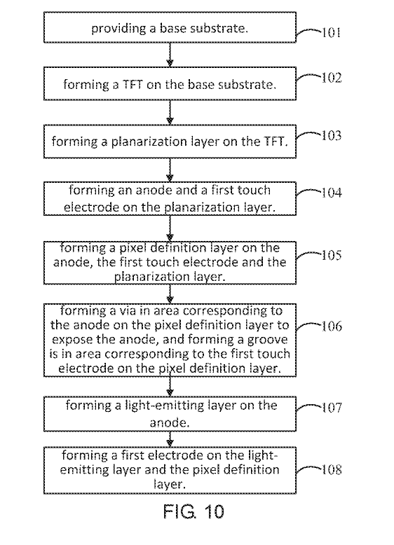

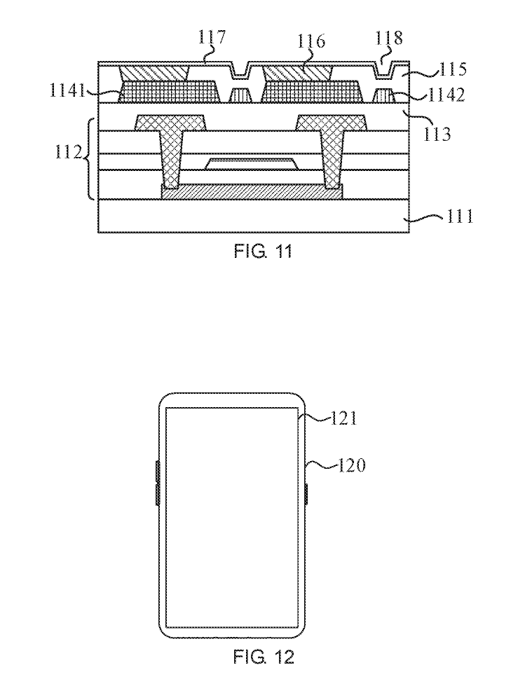

Refer to FIG. 10 and FIG. 11. FIG. 11 is a flowchart showing the manufacturing method for display panel provided by another embodiment of the present invention. The method comprises:

Step 101: providing a base substrate.

Step 102: forming a TFT on the base substrate.

Step 103: forming a planarization layer on the TFT.

Step 104: forming an anode and a first touch electrode on the planarization layer.

Step 105: forming a pixel definition layer on the anode, the first touch electrode and the planarization layer.

Step 106: forming a via in area corresponding to the anode on the pixel definition layer to expose the anode, and forming a groove is in area corresponding to the first touch electrode on the pixel definition layer.

Step 107: forming a light-emitting layer on the anode,

Step 108: forming a first electrode on the light-emitting layer and the pixel definition layer.

As shown in FIG. 11, FIG. 11 is a cross-sectional view showing display panel of the manufacturing method for display panel provided by another embodiment of the present invention. The display panel comprises a base substrate 111, a TFT 112, a planarization layer 113, an anode 141 and a first touch electrode 1142, a pixel definition layer 115, a light-emitting layer 116, and a first electrode 117, wherein a groove 118 is formed in area corresponding to the first touch electrode on the pixel definition layer.

In the present embodiment, the arrangement of the first touch electrodes and the second touch electrodes is the same as on the previous embodiment and will not be repeated here.

Compared to the known technology, the manufacturing method for the display panel provided by the present invention, by forming a first touch electrode at the layer of the anode, forming light-emitting layer and first electrode on the anode, uses the first electrode as a cathode of the display panel and a second touch electrode of the display panel in a time division manner. As such, the touch function is integrated into the display panel to reduce the thickness of the display and save production cost. Also, reducing the thickness of the pixel definition layer corresponding to the first touch electrode can enhance the touch sensitivity.

It should be noted that each of the embodiments in this specification is described in a progressive manner, each of which is primarily described in connection with other embodiments with emphasis on the difference parts, and the same or similar parts may be seen from each other. For the device embodiment, since it is substantially similar to the method embodiment, the description is relatively simple and the relevant description may be described in part of the method embodiment.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

What is claimed is:

1. A display device, comprising a display panel, the display panel further comprising a plurality of pixel units, each pixel unit comprising a light-emitting element and a thin film transistor (TFT), the light-emitting element comprising: an anode and a first touch electrode, disposed in a same layer, a light-emitting layer disposed on the anode and the first touch electrode, and a first electrode disposed on the light-emitting layer;
the first electrode serving as a cathode of the display panel and a second touch electrode of the display panel in a time division manner;
a planarization layer being disposed between the TFT and the light-emitting element, the anode being connected to a source or a drain of the TFT through a via in the planarization layer;
the planarization layer further comprising: a pixel definition layer located in non-light-emitting area and covering the anode, the first touch electrode and the planarization layer, serving as an insulating layer between the first touch electrode and the second touch electrode, the pixel definition layer having a thickness at area corresponding to the first touch electrode less than a thickness at other areas of the pixel definition layer;
the first touch electrode being disposed between two adjacent anodes.

2. The display panel as claimed in claim 1, wherein:
the first touch electrodes are evenly arranged in column direction, the second touch electrodes are evenly arranged in row direction, and the first touch electrodes are arranged in the non-light-emitting area of the display panel.

3. The display panel as claimed in claim 2, wherein:
two adjacent first touch electrodes are separated by at least one column of pixel units, and two adjacent second touch electrodes are insulated from each other.

4. The display panel as claimed in claim 1, wherein:
the first touch electrodes are evenly arranged in row direction, the second touch electrodes are evenly arranged in column direction, and the first touch electrodes are arranged in the non-light-emitting area of the display panel.

5. The display panel as claimed in claim 4, wherein:
two adjacent first touch electrodes are separated by at least one row of pixel units, and two adjacent second touch electrodes are insulated from each other.

6. A display panel, comprising a plurality of pixel units, each pixel unit comprising a light-emitting element and a thin film transistor (TFT), the light-emitting element comprising: an anode and a first touch electrode, disposed in a same layer, a light-emitting layer disposed on the anode and the first touch electrode, and a first electrode disposed on the light-emitting layer;
the first electrode serving as a cathode of the display panel and a second touch electrode of the display panel in a time division manner.

7. The display panel as claimed in claim 6, wherein:
a planarization layer disposed between the TFT and the light-emitting element, the anode being connected to a source or a drain of the TFT through a via in the planarization layer;
the planarization layer further comprising: a pixel definition layer located in non-light-emitting area and covering the anode, the first touch electrode and the planarization layer, serving as an insulating layer between the first touch electrode and the second touch electrode, the pixel definition layer having a thickness at area corresponding to the first touch electrode less than a thickness at other areas of the pixel definition layer.

8. The display panel as claimed in claim 6, wherein:
the first touch electrodes are evenly arranged in column direction, the second touch electrodes are evenly arranged in row direction, and the first touch electrodes are arranged in the non-light-emitting area of the display panel,

9. The display panel as claimed in claim 8, wherein:
two adjacent first touch electrodes are separated by at least one column of pixel units, and two adjacent second touch electrodes are insulated from each other.

10. The display panel as claimed in claim 6, wherein:
the first touch electrodes are evenly arranged in row direction, the second touch electrodes are evenly arranged in column direction, and the first touch electrodes are arranged in the non-light-emitting area of the display panel.

11. The display panel as claimed in claim 10, wherein:
two adjacent first touch electrodes are separated by at least one row of pixel units, and two adjacent second touch electrodes are insulated from each other.

12. The display panel as claimed in claim 6, wherein:
the first touch electrode is disposed between two adjacent anodes.

13. A manufacturing method for display panel, comprising:
providing a base substrate;
forming a thin film transistor (TFT) on the base substrate;
forming an anode and a first touch electrode on the TFT, wherein the anode and the first touch electrode being disposed in a same layer;
forming a light-emitting layer and a first electrode successively on the anode;
wherein the first electrode serving as a cathode of the display panel and a second touch electrode of the display panel in a time division manner.

14. The manufacturing method for display panel as claimed in claim 13, wherein the step of forming an anode and a first touch electrode on the TFT further comprises:
forming a planarization layer on the TFT;
forming the anode and the first touch electrode on the planarization layer;
the step of forming a light-emitting layer and a first electrode successively on the anode further comprises:
forming a pixel definition layer on the anode, the first touch electrode and the polarization layer;
forming a via on the pixel definition layer at area corresponding to the anode to expose anode, and forming a groove on the pixel definition layer at area corresponding to the first touch electrode;
forming a light-emitting layer on the anode;
forming a first electrode on the light-emitting layer and the pixel definition layer.

15. The manufacturing method for display panel as claimed in claim 14, wherein:
the anode is connected to a source or a drain of the TFT through a via on the planarization layer; the pixel definition layer is located in non-light-emitting area and covers the anode, the first touch electrode and the planarization layer, serves as an insulating layer between the first touch electrode and the second touch electrode, the pixel definition layer has a thickness at area corresponding to the first touch electrode less than a thickness at other areas of the pixel definition layer.

16. The manufacturing method for display panel as claimed in claim 13, wherein:
the first touch electrodes are evenly arranged in column direction, the second touch electrodes are evenly arranged in row direction, and the first touch electrodes are arranged in the non-light-emitting area of the display panel.

17. The manufacturing method for display panel as claimed in claim 16, wherein:
two adjacent first touch electrodes are separated by at least one column of pixel units, and two adjacent second touch electrodes are insulated from each other.

18. The manufacturing method for display panel as claimed in claim 13, wherein:
the first touch electrodes are evenly arranged in row direction, the second touch electrodes are evenly arranged in column direction, and the first touch electrodes are arranged in the non-light-emitting area of the display panel.

19. The manufacturing method for display panel as claimed in claim 18, wherein:
two adjacent first touch electrodes are separated by at least one row of pixel units, and two adjacent second touch electrodes are insulated from each other.

20. The manufacturing method for display panel as claimed in claim 13, wherein:
the first touch electrode is disposed between two adjacent anodes.
